(19) United States
(12) Patent Application Publication
(10) Pub. No.: US 2005/0057016 A1
(43) Pub. Date: Mar. 17, 2005

(54) Apparatus and method for detection of a latching device

(76) Inventors: Daniel A. Martinez, El Paso, TX (US); Arquimedes Godoy, Juarez (MX); Jose L. Almaraz, Juarez (MX); Juan C. Lozano, Juarez (MX)

Correspondence Address: DELPHI TECHNOLOGIES, INC., M/C 480-410-202, PO BOX 5052, TROY, MI, 48007, US

(21) Appl. No.: 10/664,128

(22) Filed: Sep. 17, 2003

(51) Int. Cl. B60G 1/00

(52) U.S. Cl. 280/124.152

(57) ABSTRACT

A detection device for use with a universal anchor of a vehicle, comprising: a housing being configured to be fixedly secured to the universal anchor; a moveable member slidably received within said housing; and a sensing switch configured to detect the movement of said movable member, said sensing switch providing a detectable signal when said movable member is moved.

### CROSS REFERENCE TO RELATED APPLICATIONS

This application is related to commonly owned and assigned United States Patent Application serial no.______, attorney docket no. DP-310001, entitled: “APPARATUS AND METHOD FOR DETECTION OF A LATCHING DEVICE” filed contemporaneously with this application. The contents of which are incorporated herein by reference thereto.

### TECHNICAL FIELD

This application relates to sensors, and in particular, a sensing apparatus for an anchoring device in a vehicle.

### BACKGROUND

Universal anchors or anchor points are provided in vehicles. These universal anchors are located throughout the vehicle to provide an anchoring point for a tethering device or latching device that is secured to a child seat at one end and has a securement mechanism for engaging the anchor at the other end.

Airbag modules or supplemental inflatable restraint systems have become common in vehicles. An airbag module typically comprises an inflatable cushion and an inflator within a housing. The module is installed in a desired position within the vehicle, such as the steering wheel, the dashboard, the seat, the A-pillar, and other locations. The inflatable cushion is stored in a folded position within the housing in fluid communication with the inflator. In response to an activation event or occurrence, a sensor or sensing device employing a control algorithm provides a signal for activating the inflator. The inflator then provides a supply of inflating gas to the cushion deploying it from the housing.

Controllers and/or the control algorithms used with inflatable restraint systems receive multiple inputs from multiple sensors wherein deployment of the inflatable restraint may partially depend on information supplied by such sensors.

### SUMMARY

A method and apparatus for providing a signal to a control module indicating whether a latching device is secured to a universal anchor point.

A detection device for use with a universal anchor of a vehicle, comprising: a housing being configured to be fixedly secured to the universal anchor; a moveable member slidably received within said housing; and a sensing switch configured to detect the movement of said movable member, said sensing switch providing a detectable signal when said movable member is moved.

A method for determining whether a securement member of a child seat is secured to a universal anchor of a vehicle, comprising: positioning a detecting device on the universal anchor, the detecting device comprising a movable member which effectively blocks an opening of the anchor when it is in a first position; and providing a signal to a controller when the movable member is moved from said first position, wherein the movement of the movable member is caused by engaging a securement member on the anchor.

A universal anchor for a structural member of a vehicle, comprising: an anchor being configured to define an opening, the anchor being secured to the structural member; a detection device, comprising: a housing being secured to the anchor, a movable member slidably received within the housing for movement between a first position and a second position, the movable member effectively blocking the opening when the movable member is in the first position; and a sensing device for detecting movement of the movable member from the first position.

A universal anchor for a structural member of a vehicle, comprising: an anchor being configured to define an opening, the anchor being secured to the structural member and the anchor is capable of movement with respect to the structural member when a tension force is applied to the anchor; a detection device, comprising a housing being secured to the anchor, a movable member slidably received within the housing for movement between a first position and a second position, the movable member effectively blocking the opening when the movable member is in the first position; a sensing device for detecting movement of the movable member from the first position; a securement assembly for movably securing the anchor to the structural member; and a tension detection device being positioned to detect movement of the anchor with respect to the securement assembly.

The above-described and other features and advantages of the present invention will be appreciated and understood by those skilled in the art from the following detailed description, drawings, and appended claims.

### BRIEF DESCRIPTION OF THE DRAWINGS

FIG. 1 is a perspective view of a universal anchor;

FIG. 2 is an exploded perspective view of a sensing assembly contemplated for use with the universal anchor of FIG. 1;

FIGS. 3A-5 are various perspective views of a sensing assembly contemplated for use with the universal anchor of FIG. 1;

FIG. 6 is an exploded perspective view of an alternative embodiment of the present invention;

FIG. 7 is a side elevational view of the FIG. 6 embodiment;

FIGS. 8-11 are perspective views of the FIG. 6 embodiment;

FIGS. 12-13 are perspective views of an exemplary embodiment of the present invention;

FIGS. 14A-17F illustrate securement of latching devices to anchor assemblies having exemplary embodiments of the present invention secured thereto; and

FIG. 18 illustrates an example of detectable movement of a movable member when a latching device is secured to an anchor device.

### DETAILED DESCRIPTION OF EXEMPLARY EMBODIMENTS

Disclosed herein is an apparatus, which is secured to a portion of a universal anchor. The apparatus comprises a movable member which must be moved in order to allow a latching device or member to be secured to the anchor. The movement of the movable member is detected by a sensing switch or assembly which provides a signal indicative of movement of the movable member to a controller.

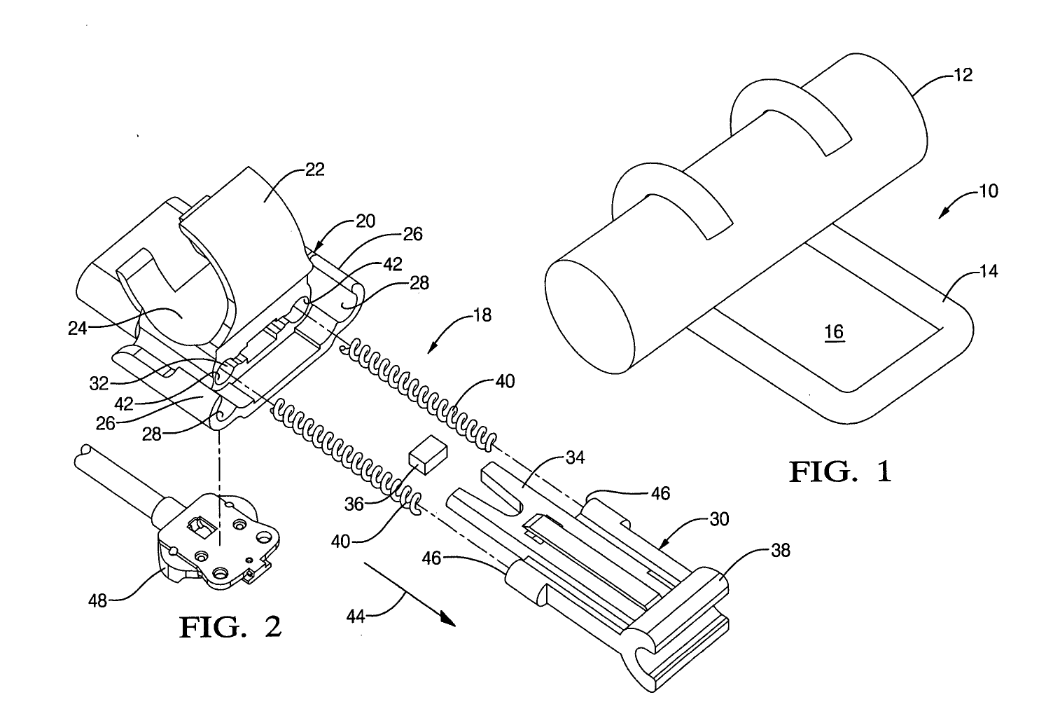

Referring now to FIG. 1 an example of an anchoring device 10 is illustrated. Of course, many other configurations of anchoring device 10 are contemplated in accordance with exemplary embodiments of the present invention. As illustrated in FIG. 1 anchoring device 10 comprises a bar 12 (partially shown) and an anchor 14 configured to wrap around and engage a portion of bar 12 as well as provide an opening 16 that is used to allow an engagement device to engage a portion of anchor 14. In an exemplary embodiment, anchor 14 is manufactured out of a durable material such as steel.

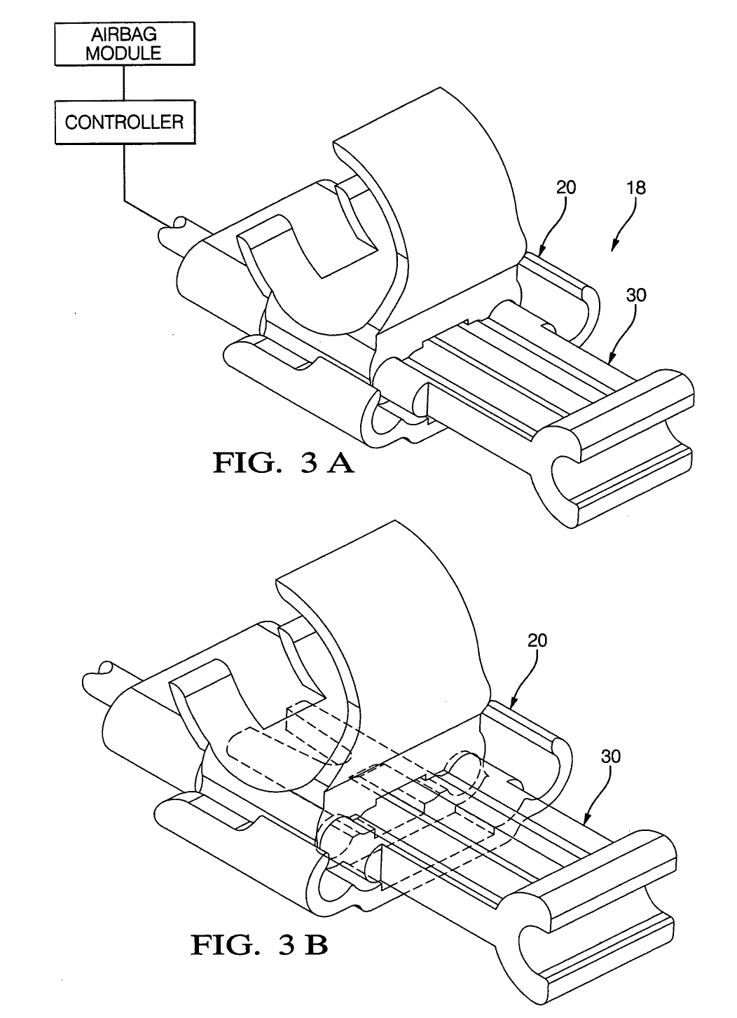

Referring now to FIG. 2 an exploded view of a detection device 18 is provided. The detection device illustrated in FIG. 2 is contemplated for use with the anchoring device illustrated in FIG. 1 however, and as will be illustrated and discussed herein various embodiments of the detection device are contemplated with various configurations of the anchoring device.

Detection device 18 comprises a housing 20 configured to engage anchor device 10. Housing 20 is preferably constructed out of a lightweight, easily molded material such as plastic. Housing 20 further comprises an engagement portion 22, which defines a receiving area 24 for receiving and engaging a portion of bar 12. In an exemplary embodiment engagement portion 22 is configured to snap on or frictionally engage bar 12. Housing 20 also comprises a pair of anchor engaging portions 26 each of which defines a receiving area 28 for receiving and engaging a portion of anchor 14 when housing 20 is secured to anchor 14.

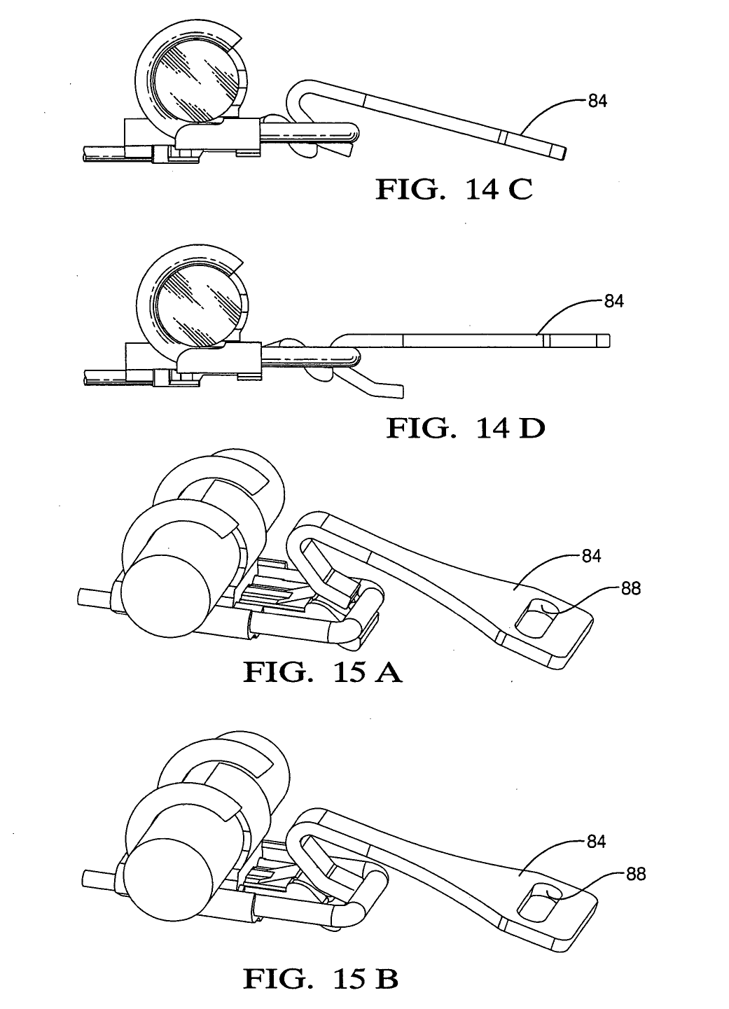

Detection device 18 further comprises a movable member 30, which is slidably received within an opening 32 of housing 20. The dimensions of housing 20 and movable member 30 are such that the movable member 30 is capable of movement in a range defined by a first position (e.g., FIG. 14A) and a second position (e.g., FIG. 14B). The first position corresponds to no latching mechanism secured to the anchor, and the second position corresponds to movement caused by a latching mechanism being secured to the anchor.

Movable member 30 further comprises a slide portion 34 disposed at one end. Slide portion 34 is configured to receive and engage a magnet 36. Accordingly, magnet 36 moves when slide portion 34 slides in opening 32, and as will be discussed herein, causes a signal to be generated which indicates that the movable member has been moved to a position, which corresponds to an engagement device being secured to anchor 14. In an exemplary embodiment the magnet is over-molded by the slide portion negating the need for nickel plating of the magnet. Alternatively, the magnet may be disposed in an opening of the slide portion.

Movable member 30 also comprises an actuating end 38 or end that is opposed to slide portion 34. Actuating end 38 is configured to make contact with or be in close proximity with a portion of anchor 14 such that opening 16 is substantially closed or blocked by movable member 30 when the movable member is in a first position corresponding to anchor device not having a latching mechanism secured thereto. For example, the position illustrated in FIG. 5. In an alternative embodiment, a metal head is molded onto movable member 30 to provide actuating end 38 that has a durable surface for interaction with the engaging means or hook. In another alternative embodiment movable member is configured to have at least one aperture to allow liquids, which may have been accidentally spilled on the device to pass therethrough.

In order to maintain the movable member at the position illustrated in FIG. 5 a pair of biasing members or springs 40 are received in complimentary spring openings 42, which comprise a portion of opening 32. In an exemplary embodiment openings 42 are circular and slidably receive springs or biasing members therein. Of course, other configurations of springs 40 and openings 42 are considered to be within the scope of exemplary embodiments of the present invention. Movable member is also configured to reduce or minimize friction between movable member 30 and the opening of housing into which movable member 30 is slidably received. Once assembled, movable member 30 is biased in the direction of arrow 44 by springs making contact with shoulder portions 46 of movable member 30 at one end and a portion of opening 32 at the other end. Accordingly, movable member is biased into a closed position and is configured for ease of movement due to an engaging member being placed on the anchor while preventing inadvertent movement or opening not associated with an engaging member being placed on the anchor.

Detection device 18 also comprises a sensing assembly or switch 48, which is secured to housing 20. In an exemplary embodiment switch 48 is secured to housing 20 by rivets, screws or other mechanical securement features integral with the housing or the switch. Alternatively and/or in combination with the mechanical securement, switch 48 can be heat staked onto housing 20 with heat staking portions on either or both the sensing switch and the housing. Sensing switch 48 is configured and positioned to detect movement of magnet 36 by movable member 30. Sensing switch 48 is positioned to have the detection face covered by the slider to prevent debris (magnetic or otherwise), which may affect the performance of the sensing switch. In addition, the configuration of the detection device enables the air-gap between the magnet and the sensing switch to be minimized, which will reduce magnet material cost. Accordingly, detection device 18 is configured to provide a signal indicative of movement of movable member 30, which relates to the securement of a latching mechanism to anchor 14.

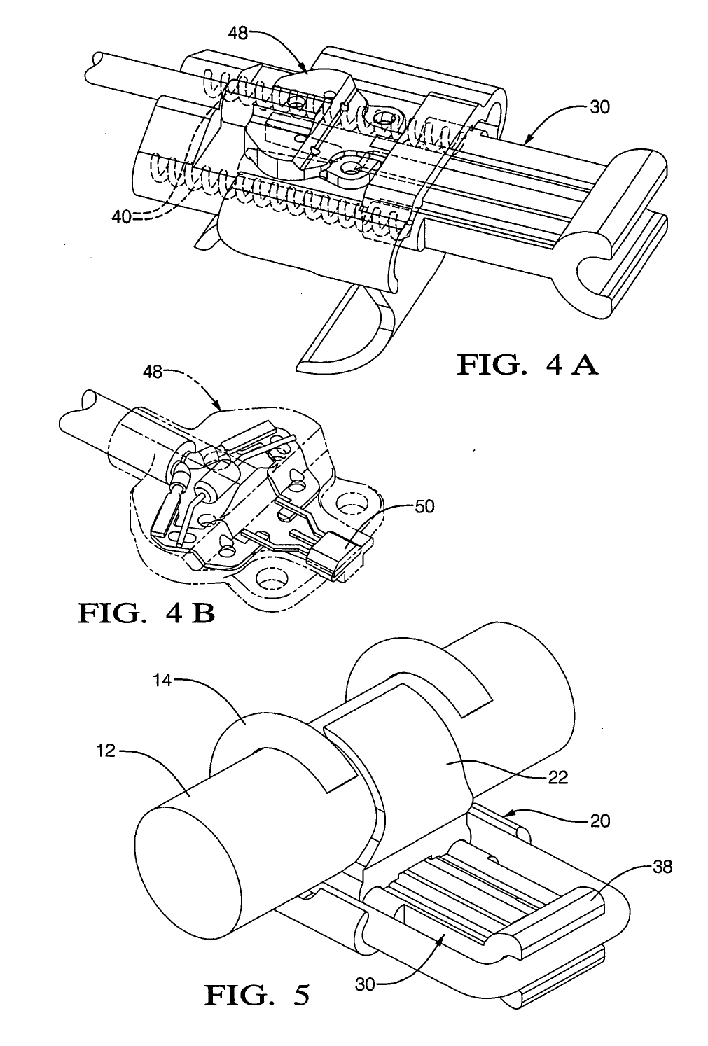

Referring now to FIGS. 2-4A, an assembled detection device 18 is illustrated. FIG. 4B shows an enlarged view of sensing assembly 48. Sensing assembly 48 comprises a Hall effect device 50 and complimentary circuit, which in an exemplary embodiment is encased in a plastic housing or other equivalent means for over-molding and encasing the circuit. The operation of a Hall effect device is known to those skilled in the related arts. Sensing assembly 48 is fixedly secured to housing 20 such that movement of movable member 30 in the range defined by the first position and the second position, causes magnet 36 to move with respect to Hall effect device 50, which remains stationary.

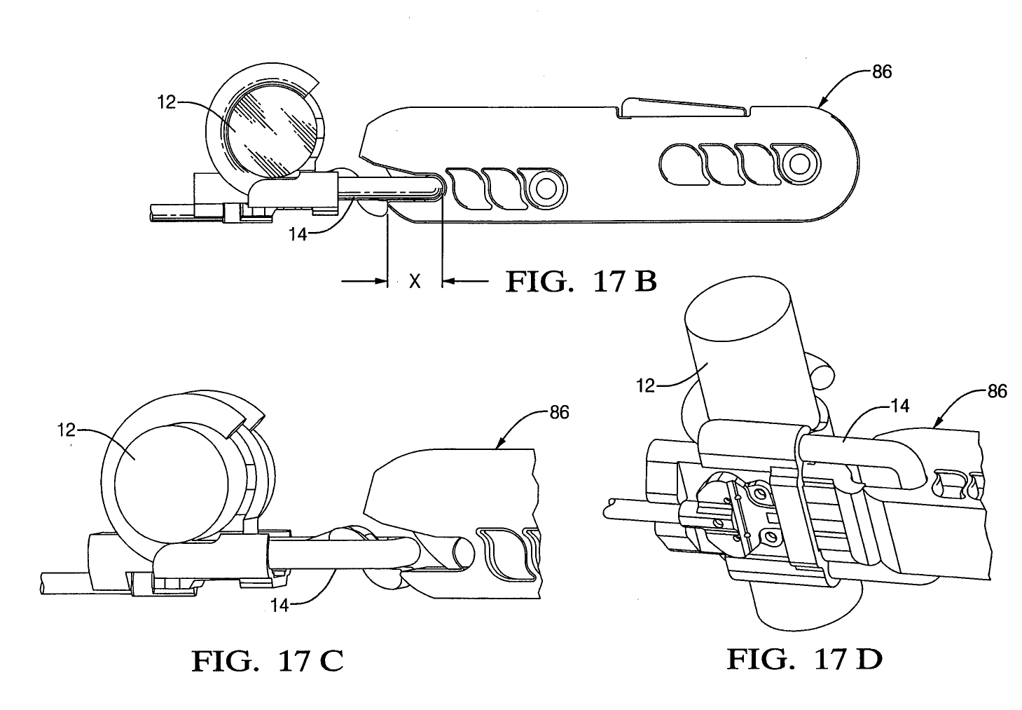

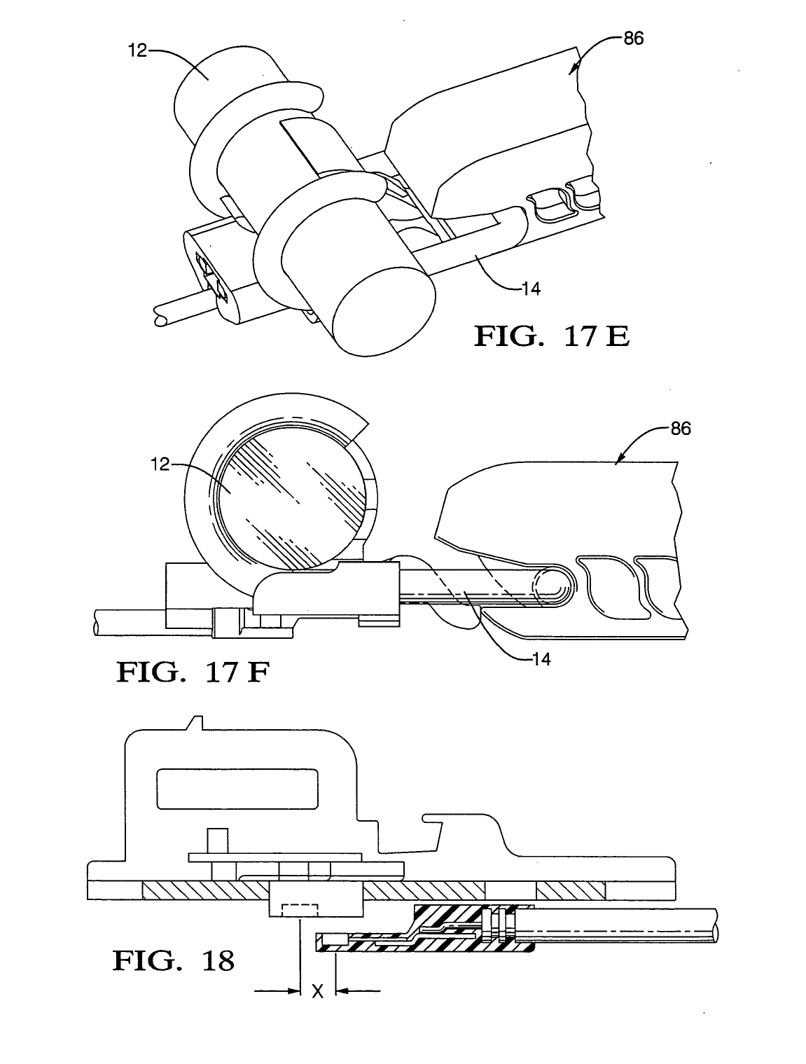

Accordingly, and as movable member 30 moves in the range defined by the first position (e.g., FIG. 14A) and the second position (e.g., FIG. 14A), magnet 36 moves with respect to Hall effect device 50. See also FIGS. 17A and 17B as well as FIG. 18 wherein movement of the magnet is illustrated. For example, in FIG. 18 the displaced movement of the magnet towards the Hall effect device is illustrated by the distance “X”.

The Hall effect device will sense the strength of the magnetic field of the approaching magnet, and depending on the strength of the magnetic field, the Hall effect device will generate an electric signal (voltage or current), which can be used to determine the position of movable member 30. Alternatively, the device can be configured such that the magnet moves further away from the Hall effect device when the movable member is moved and the reduction in the magnetic field will be sensed by the Hall effect device. In either embodiment, the signal is received by an algorithm of a system controller in the vehicle having the detection device 18 installed therein. The system controller will then input the signal into algorithm in order to determine if the received signal corresponds to a predetermined condition (e.g., child seat and/or other vehicle conditions), which would cause the controller to suppress an airbag module, or other device associated with that portion or seat of the vehicle. The algorithm may have a look up table of signals, which correspond to tensions and movements of the movable member which are compared to the signal received.

Although the use of a Hall effect device is described above it is also contemplated that other types of sensing devices may be used to sense movement and provide an output signal indicative thereof. For example, such alternatives include but are not limited to the following: magneto-resistor, magnetosensitive devices, anisotropic magnetoresistors, optical devices and equivalents thereof. Also, a magnetic flux deflector may be employed in lieu of a Hall effect device, an example of a flux deflector contemplated for use with exemplary embodiments of the present invention is found in United States Patent Application serial no.______, entitled “MAGNETOSENSITIVE LATCH ENGAGEMENT DETECTOR FOR A MECHANICAL FASTENING SYSTEM”, attorney docket number DP-308187, filed on May 14, 2003. The contents of which are incorporated herein by reference thereto. Of course, other types of flux deflectors are contemplated for use in the various embodiments of the present invention.

An exemplary use for the signal generated by the detection device is to provide an airbag suppression signal to an airbag module controller or supplemental restraint controller in order to determine whether or not to suppress any related devices such as hyper-tensioners, airbag modules, or seat belt pre-tensioners, etc. An example of such a device is a microcontroller of a sensing and diagnostic module for use with an airbag module, which will suppress the air bag and in one embodiment provide a signal to an indicator light to indicate that the air bag has been suppressed. In an exemplary embodiment the indicator light is located in a position within the vehicle compartment that is easily viewed by the operator and/or occupants of the same. For example, one such location of the indicator light is on the vehicle dashboard. In addition, the microcontroller may also provide an audible tone or voice response, indicating that the air bag has been suppressed.

The signal generated by the sensing assembly is propagated through a cable secured to the circuit or other means of data transmission RF, optical ect. to the controller.

Once the components of detection device 18 are assembled, they are secured to anchor device 10. Securement of device 18 to anchor device 10 in one embodiment is illustrated in FIG. 5.

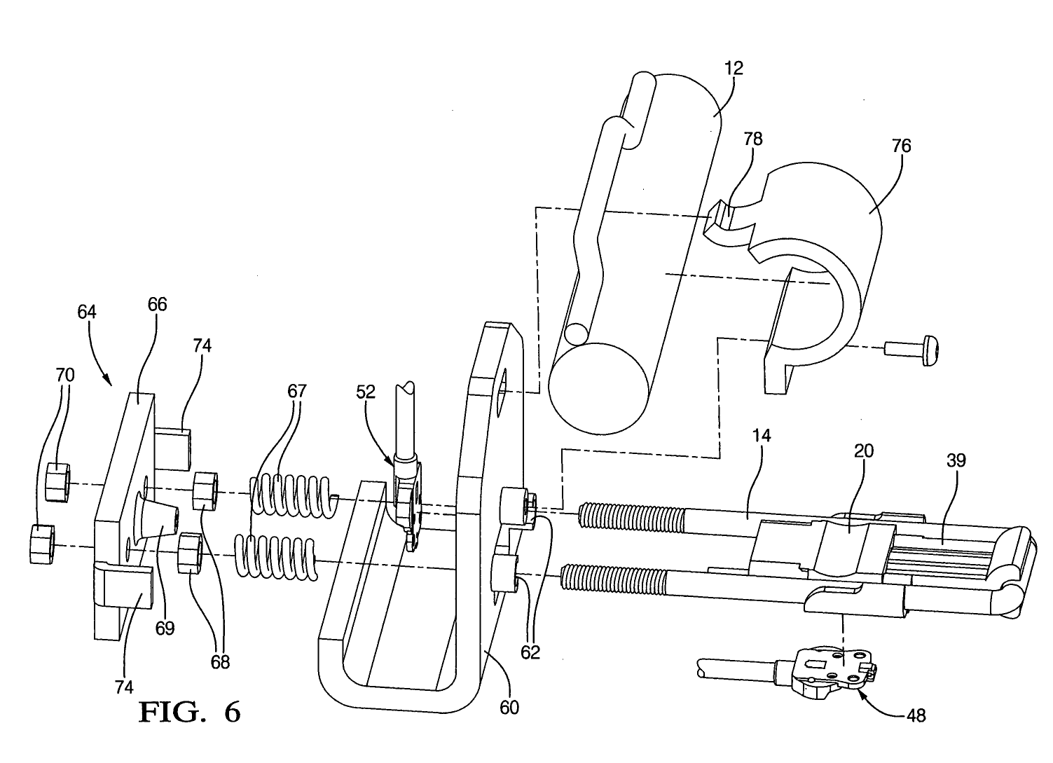

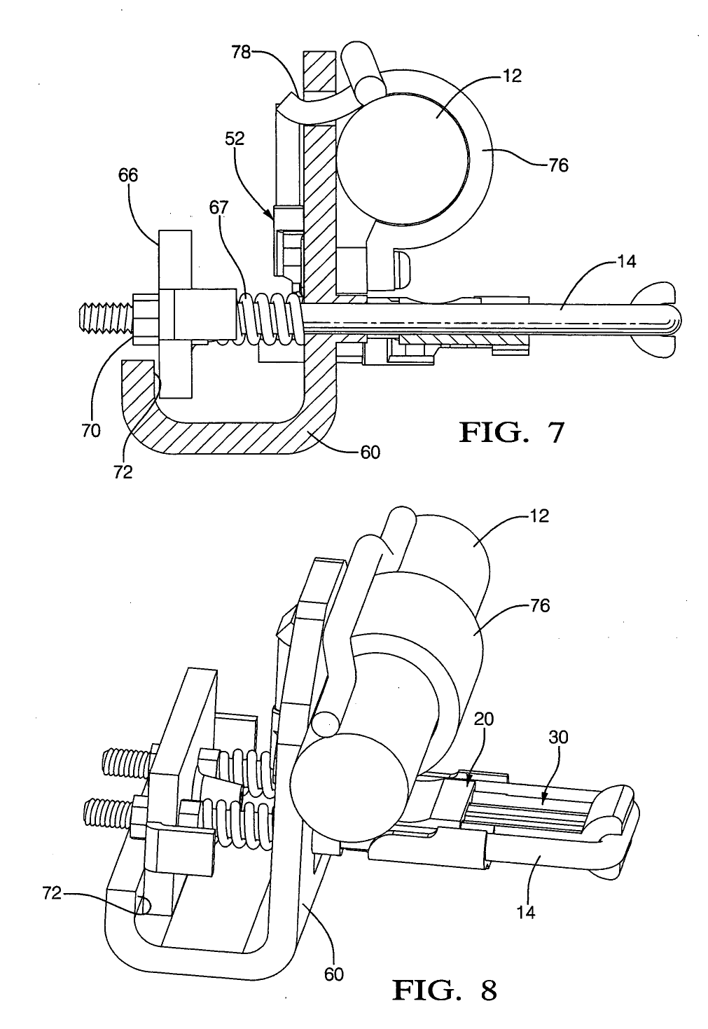

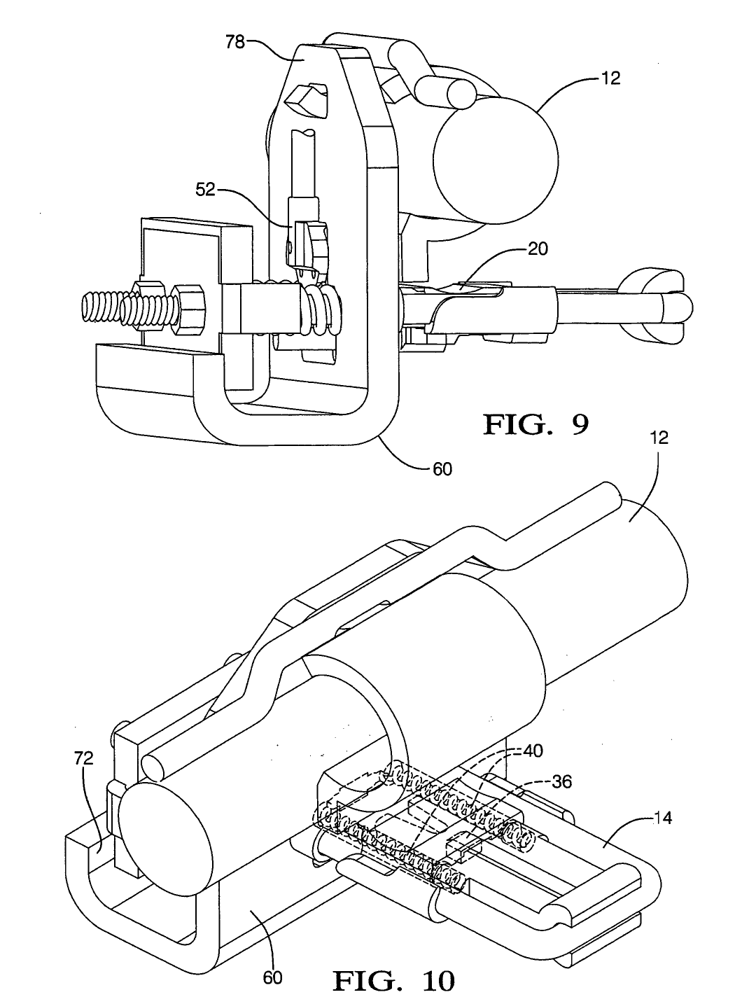

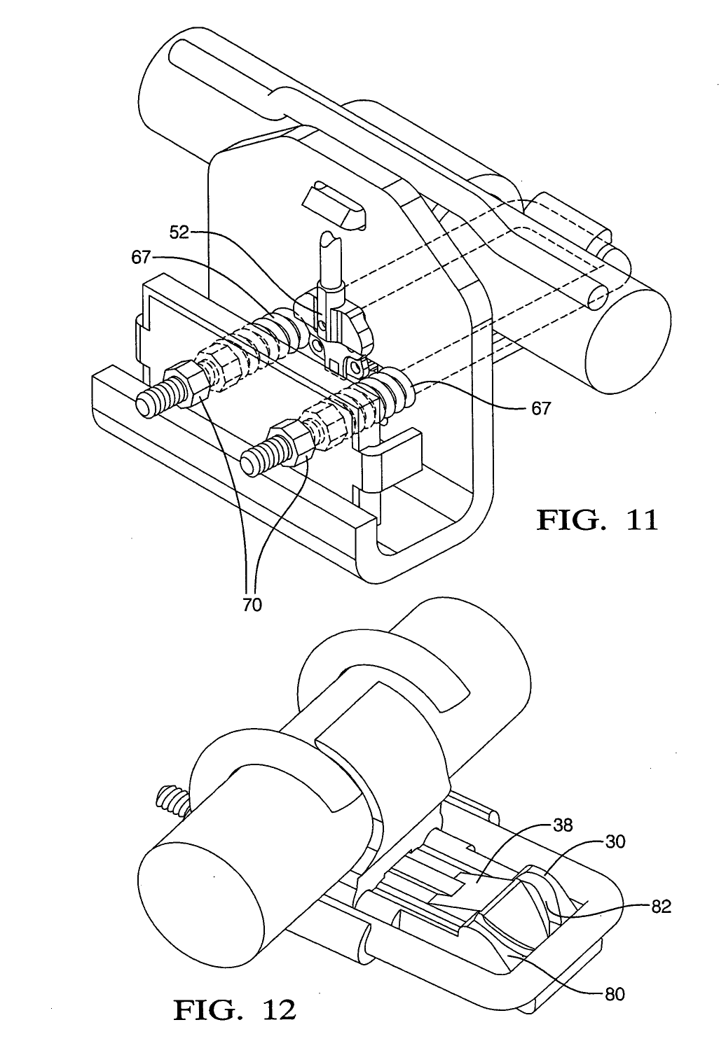

Referring now to FIGS. 6-11, an alternative embodiment is illustrated. In this embodiment, the detection device comprises a sensing assembly 48 for detecting the presence of a hook or latching device and a tension detecting switch or assembly 52. The tension will also provide a signal indicative of whether a certain amount of tension has been applied to the anchor. This tension is associated with the tension applied to the anchor by the tightening of a securement means (e.g., tether and hook) securing a child seat to the anchor. For example, as the tension is applied the biasing force of the springs is overcome and movement of a magnet closer or away from a Hall effect device of assembly 52 is detected. The movement of the magnet of a predetermined distance will correlate to a pre-determined tension being applied to the device, the pre-determined tension is determined by the biasing force of springs 67 and the corresponding movement of anchor 14. In order to provide this tension sensing feature, anchor 14 has a different configuration and is secured to a bracket 60 by passing through a pair of openings 62 disposed therein. In addition, housing 20 has a different configuration however the operation thereof is similar in that housing 20 is secured to anchor 14 and provides an opening for slidably receiving movable member 30 therein. In addition, movable member is biased into a first position illustrated in FIGS. 7-11 once the assembly is secured to the anchor. The biasing of the movable member is provided by springs 40 as discussed with respect to FIGS. 1-5.

A securement assembly 64 provides the means for movably securing anchor 14 to bracket 60 for movement under tension by for example threadingly engaging a threaded portion of anchor 14 through the use of a stopping member 66, a pair of springs 67, a pair of bushings 68 and a pair of nuts 70. Bracket 60 is configured to engage securement assembly 64 once it is secured to anchor 14 by engaging a stopping portion 72 of bracket 60, while springs 67 are positioned upon a portion of anchor 14 between bushings 68. Springs 67 provide a biasing force for maintaining the stopping member in a first position. In addition, stopping member 66 is also configured to have a pair of flanges 74, which act as stopping members for limiting the amount of travel of stopping member 66 with respect to bracket 60. Flanges 74 provide a limit for a second position of stopping member 66 with respect to bracket 60. As discussed above springs 67 provide a biasing force, which when overcome by a tension being applied to the anchor allows for movement of stopping member 66 with respect to sensing assembly 52 which is configured and positioned to detect the movement of a magnet 69 disposed for example on stopping member 66. As in the previous embodiments magnet 69 can be over-molded in place or simply received in an opening.

In order to secure the bracket bar 12 a securement member 76 is provided. Securement member 76 has an integral hook portion 78 for engaging an opening defined by a bar welded to bar 12 at one end and the other end is secured to bracket 60 by a rivet, screw, bolt or other equivalent securement means. The opening defined by the bar welded to bar 12 provides an opening large enough to receive and engage portion 78 and in an alternative embodiment is large enough to provide slight rotation or movement of the entire assembly with respect to bar 12 due to tensions applied to anchor 14 and in order to allow anchor 14 to move and provide detectable movement due to tension applied thereto. It is also understood that bracket 60 may also be configured to provide such movement. Accordingly, and after the assembly of FIGS. 6-11 is constructed the same is easily secured to bar 12 though the use of securement member 76.

As with the previous embodiment, sensing assembly 48 is fixedly secured to housing 20 such that movement of movable member 30 in the range defined by the first position and the second position, causes magnet 36 to move with respect to Hall effect device 50, which remains in a stationary position.

Accordingly, and as movable member 30 moves in the range defined by the first position (e.g., FIG. 14A) and the second position (e.g., FIG. 14D), magnet 36 moves with respect to Hall effect device 50.

The Hall effect device will sense the strength of the magnetic field of the approaching magnet, and depending on the strength of the magnetic field, the Hall effect device will generate an electric signal to determine the position of movable member 30. The electric signal being received by an algorithm of a system controller of the vehicle in which the detection device is installed. Thus, this embodiment is capable of providing two signals to the controller one for movement of the movable member and one corresponding to the tension applied to the anchor due to its detected movement.

In addition, the tension applied to the device is sensed by movement of stopping member 66 by tension detecting switch or assembly 52, which is configured to detect movement of a magnet disposed on stopping member 66. Of course, the magnet disposed on the stopping member may be located in another position wherein tension applied to the anchor causes the magnet to move and its movement is sensed by switch 52, which may also be repositioned in alternative embodiments to detect tension applied to the anchor. For ease of manufacturing tension detecting switch or assembly 52 is similar or identical to switch or assembly 48.

Again, although the use of a Hall effect device is described above it is also contemplated that other types of sensing devices may be used to sense movement and provide an output signal indicative thereof.

As yet another alternative embodiment, tension detecting switch or assembly 52 is configured to provide a signal to a motor or motor controller which is provided to provide a tension to anchor 14 until the desired tension is applied to anchor 14 via the latching mechanism secured thereto.

In yet another alternative embodiment, the detection device is only equipped with tension detecting switch or assembly 52 to provide a signal indicative of the tension applied to the anchor wherein predetermined tensions (e.g., detected positions) corresponding to a child seat being secured to the anchor are stored in the memory of the controller which receives the signal from the sensing switch. Accordingly, and in this embodiment only anchor 14 and securement assembly 64 is required. Furthermore, and in yet another alternative embodiment securement assembly 64 may be configured to provide an alternative sliding arrangement of anchor 14.

In addition, and in yet another alternative embodiment the tension detection switch or assembly 52 of the detection device is only equipped with tension detection switch or assembly 52 and a motor configured for applied tension to the anchor. In this embodiment an electric motor is positioned to provide a rotational force to a worm gear or equivalent device capable of transferring the rotational movement of the motor into a linear movement of the anchor or securement assembly wherein the motor is operated by the controller to provide the required force to provide a desirable or pre-calculated tension to the anchor when a child seat hook is engaged thereon. This embodiment may also be used in conjunction with switch 48 to detect the presence of a hook on the anchor.

In yet another alternative any one of the tension detecting embodiments can be configured to be used with an existing seat belt anchor wherein tension corresponding to the securement of a child seat will provide a signal to the airbag module controller. Detection of these tensions will be discernable as child seat belt tensions are typically higher than those associated with seat belt usage by a larger sized occupant.

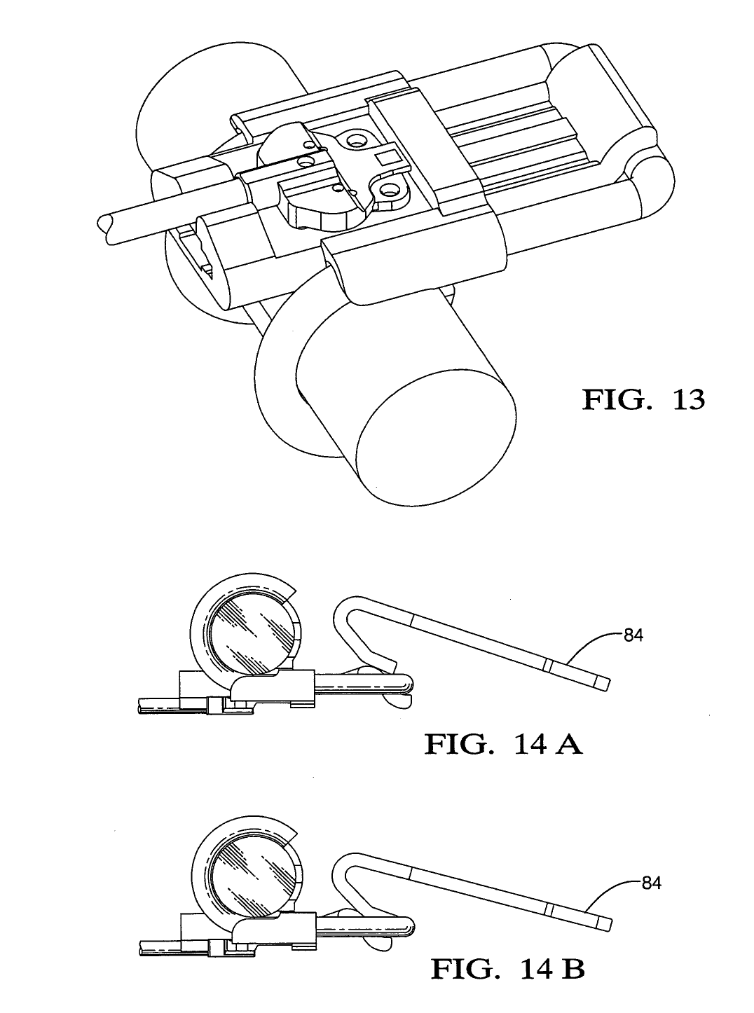

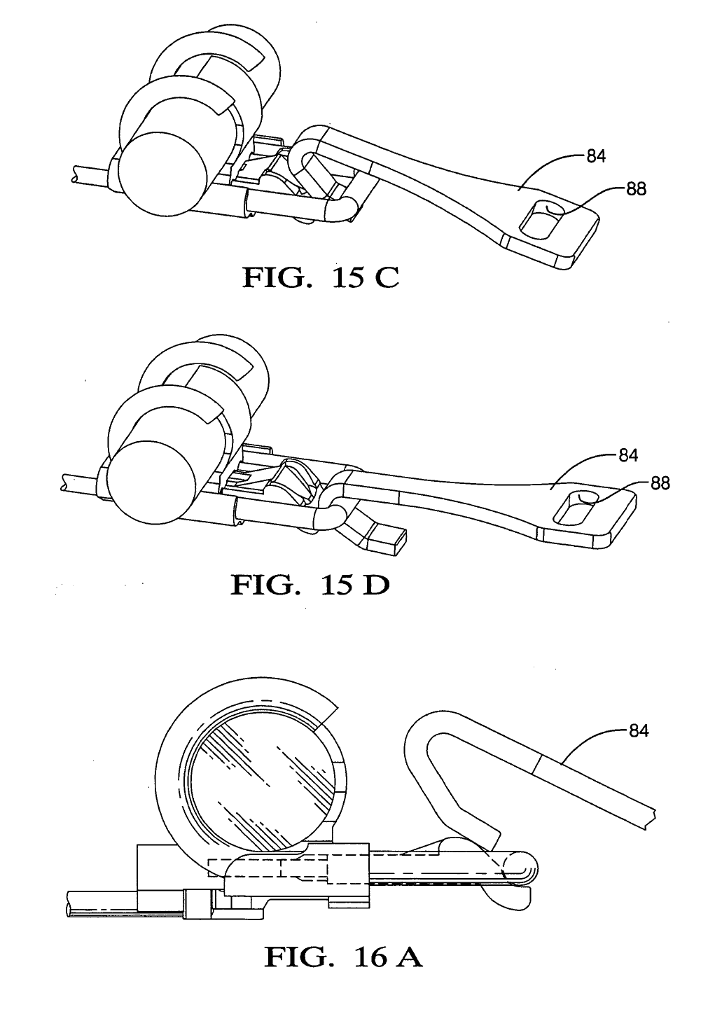

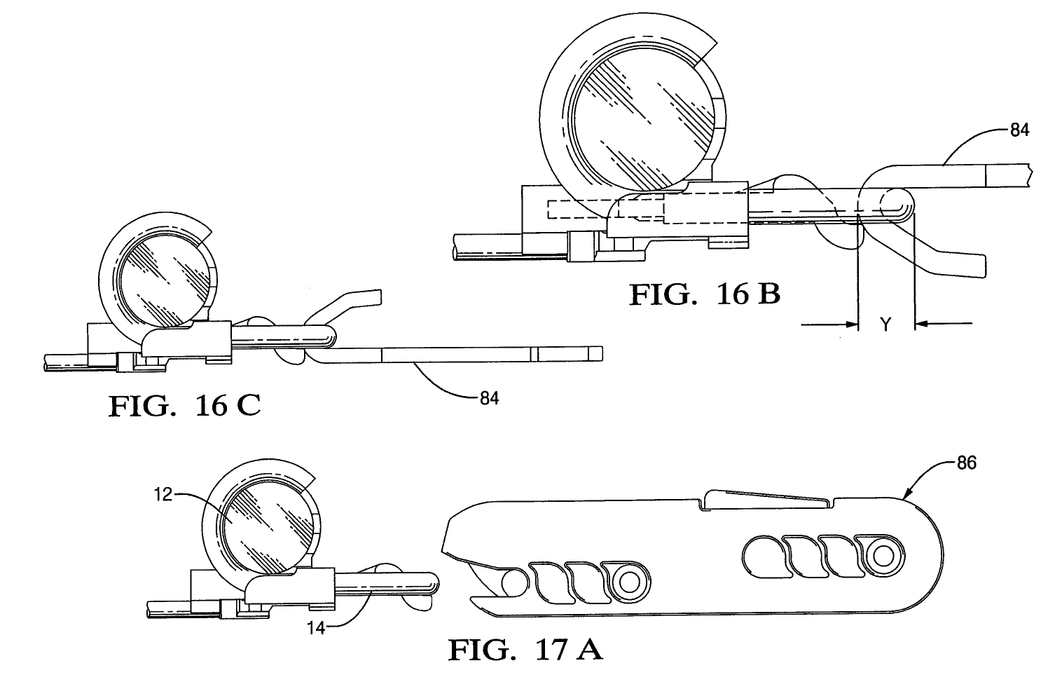

Referring now to FIGS. 12-17F an exemplary embodiment and operation thereof is illustrated. In this embodiment, actuating end 38 of movable member 30 is configured to have a head portion 80 which is angularly configured and comprises a directing channel 82, which assists in allowing a latching hook 84 or clevis type of hook 86 to engage anchor 14 by moving movable member 30. Alternatively, head portion 80 or actuating end 38 merely comprises a serpentine shape, which is configured to facilitate movement of movable member 30 as a hook is engaged onto anchor 14. The detectable movement of movable member 30 from a first position to a second position is illustrated variously in FIGS. 14A-17F. FIGS. 14A-15D illustrate a latching hook 84 being applied to engage anchor 14 by moving movable member 30. In an exemplary embodiment latching hook 84 is secured to a child seat by securing a tether within an opening 88 disposed in latching hook 84.

In addition, the biasing of springs 40 cause movable member to move back towards a hook engagement position illustrated in FIGS. 14D, 15D, 16B and 16C. The movement of movable member 30 corresponding to a clevis type slider hook 86 in FIGS. 17A-17F is from a non-engaging position to an engagement position as opposed to the non-engaging, engaging and engagement positions of FIGS. 14A-15D. In either embodiment, movable member 30 is biased by springs 40 towards the engagement position.

In an exemplary embodiment, the clevis type slider hook assembly 86 comprises a housing for housing the hook wherein the hook is mechanically biased into a closed or locked position. In addition, a switch is positioned on the exterior of the housing in order to lock or unlock the hook as the hook is secured to the anchor. It is also contemplated that hook assembly will be fixedly secured to a child seat at one end while engaging the anchor device at the other end.

Accordingly, and through usage of any of the embodiments disclosed herein, the detection device provides a means for providing an output signal indicative of whether a latching device of any type of hook or connection means is engaged or latched upon the anchor as well as providing a signal indicative of a tension applied to the anchor. In accordance with an exemplary embodiment the latching device is secured to a child seat at one end and the anchor at the other end wherein movement of the movable member causes a signal to be generated and the signal is employed in a control algorithm.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. It should also be noted that the terms “first”, “second”, and “third” and the like may be used herein to modify elements performing similar and/or analogous functions. These modifiers do not imply a spatial, sequential, or hierarchical order to the modified elements unless specifically stated.

1. A detection device for use with a universal anchor of a vehicle, comprising:
a housing being configured to be fixedly secured to the universal anchor;
a moveable member slidably received within said housing; and
a sensing switch configured to detect the movement of said moveable member, said sensing switch providing a detectable signal when said moveable member is moved.

2. The detection device as in claim 1, wherein said sensing switch comprises a Hall effect device positioned to sense the magnetic field of a magnet disposed on said movable member.

3. The detection device as in claim 1, wherein said movable member comprises a slide portion configured to be slidably received within an opening of said housing, said magnet being disposed on said slide portion.

4. The detection device as in claim 1, wherein said detectable signal being received by a controller of an airbag module.

5. The detection device as in claim 1, wherein said movable member is biased into a first position, wherein said movable member must be moved from said first position to allow a hook to engage the anchor.

6. The detection device as in claim 5, wherein said sensing switch comprises a Hall effect device positioned to sense the magnetic field of said magnet.

7. The detection device as in claim 6, wherein said movable member comprises a slide portion configured to be slidably received within an opening of said housing, said magnet being disposed on said slide portion.

8. The detection device as in claim 7, wherein said detectable signal being received by a controller of an airbag module and said controller suppresses the operation on an airbag module in response to said detectable signal received from said sensing switch.

9. The detection device as in claim 1, wherein the anchor defines an opening and said movable member effectively blocks the opening when said movable member is in a first position and movement of said movable member from said first position is detected by said sensing switch.

10. The detection device as in claim 9, wherein said movable member comprises a slide portion and an actuating end, said slide portion being configured to be slidably received within an opening of said housing.

11. The detection device as in claim 10, wherein said actuating end is configured to have a channel for guiding a hook as it is being secured to the anchor.

12. The detection device as in claim 1, wherein the movement of said movable member is linear.

13. A method for determining whether a securement member of a child seat is secured to a universal anchor of a vehicle, comprising:
positioning a detecting device on the universal anchor, said detecting device comprising a movable member which effectively blocks an opening of the anchor when it is in a first position; and
providing a signal to a controller when said movable member is moved from said first position, wherein the movement of said movable member is caused by engaging a securement member on the anchor.

14. The method as in claim 13, wherein said movable member further comprises a magnet and said detecting device further comprises a sensing assembly for sensing the magnetic field of said magnet, said sensing assembly providing said signal.

15. The method as in claim 14, wherein said sensing assembly further comprises a Hall effect device and related circuitry and said controller suppresses the operation on an airbag module in response to said signal.

16. A universal anchor for a structural member of a vehicle, comprising:
an anchor being configured to define an opening, said anchor being secured to the structural member and said anchor is capable of movement with respect to the structural member when a tension force is applied to said anchor;
a detection device, comprising a housing being secured to said anchor, a movable member slidably received within said housing for movement between a first position and a second position, said movable member effectively blocking said opening when said movable member is in said first position; and
a sensing device for detecting movement of said movable member from said first position.

17. The universal anchor as in claim 16, further comprising:
a bracket and securement assembly for movably securing said anchor to the structural member;
a tension detection device disposed on said bracket, said tension detecting device being configured to detect movement of said anchor; and
a securement member for securing said bracket to the structural member.

18. The universal anchor as in claim 17, wherein said securement member further comprises a hook portion for engaging an opening on the structural member.

19. The universal anchor as in claim 17, wherein said securement assembly further comprises: a stopping member for engaging a portion of said bracket said stopping member being secured to said anchor and said stopping member moves as said anchor moves when a tension force is applied to said anchor.

20. The universal anchor as in claim 19, wherein said stopping member is biased against said bracket by at least one spring disposed about a portion of said anchor.

21. The universal anchor as in claim 20, wherein said tension detection device detects movement of a magnet disposed on said stopping member and said sensing device detects movement of a magnet disposed on said moveable member.

22. A universal anchor for a structural member of a vehicle, comprising:
an anchor being configured to define an opening, said anchor being secured to the structural member and said anchor is capable of movement with respect to the structural member when a tension force is applied to said anchor;
a detection device, comprising a housing being secured to said anchor, a movable member slidably received within said housing for movement between a first position and a second position, said movable member effectively blocking said opening when said movable member is in said first position;
a sensing device for detecting movement of said movable member from said first position;
a securement assembly for movably securing said anchor to the structural member; and
a tension detection device being positioned to detect movement of said anchor with respect to said securement assembly.

23. The universal anchor as in claim 22, further comprising: a motor configured to apply a force to said anchor, said force moving said anchor with respect to said securement assembly.

24. The universal anchor as in claim 23, wherein said tension detecting device detects movement of a magnet when said anchor is moved with respect to said securement assembly and said sensing device detects movement of a magnet disposed on said moveable member.

25. The universal anchor as in claim 23, wherein said tension detecting device provides a signal to a controller indicative of movement of said anchor and said sensing device provides a signal to said controller indicative of movement said movable member and said motor receives operational signals from said controller in response to said signals provided by said tension detecting device and said sensing device.

26. The universal anchor as in claim 25, wherein said controller suppresses the operation on an airbag module in response to predetermined signals received from either or both said tension detecting device and said sensing device.
